(19) United States
(12) Patent Application Publication
(10) Pub. No.: US 2016/0204435 A1
(43) Pub. Date: Jul. 14, 2016

(54) NEGATIVE ELECTRODE MATERIAL, NEGATIVE ELECTRODE ACTIVE MATERIAL, NEGATIVE ELECTRODE AND ALKALI METAL ION BATTERY

(71) Applicant: SUMITOMO BAKELITE CO., LTD., Tokyo (JP)

(72) Inventors: Yukiharu Ono, Tokyo (JP); Takeshi Takeuchi, Tokyo (JP)

(73) Assignee: Sumitomo Bakelite Co., Ltd., Tokyo (JP)

(21) Appl. No.: 14/913,480

(22) PCT Filed: Aug. 13, 2014
(86) PCT No.: PCT/JP2014/071367

§ 371 Date: Feb. 22, 2016

(30) Foreign Application Priority Data
Aug. 23, 2013 (JP) 2013-173126
Aug. 23, 2013 (JP) 2013-173174

(51) Int. Cl. H01M 4/587; H01M 10/0525; H01M 4/134; H01M 10/0569; H01M 10/0568; H01M 4/133; H01M 10/054

(52) U.S. Cl. CPC H01M 4/587; H01M 4/133; H01M 10/0525; H01M 10/054; H01M 10/0569; H01M 10/0568; H01M 4/134; H01M 2004/027

(57) ABSTRACT

There is provided a carbonaceous negative electrode material used for an alkali metal ion battery. The average layer plane spacing d₀₀₂ of a (002) plane obtained using an X-ray diffraction method in which a CuKα ray is used as a radiation source is 0.340 nm or greater, and either or both the following condition A and condition B are satisfied. In addition, in a specific condition, the cross section includes a first region (101) and a second region (103) having different hardness values measured by means of micro-hardness measurement. Alternatively, the cross section includes a first region (101) and a second region (103) having different intensities of a peak, which corresponds to a lattice constant of graphite, of a curve obtained by means of an image analysis of an electron beam diffraction image observed using a transmission electron microscope.

### TECHNICAL FIELD

The present invention relates to a negative electrode material, a negative electrode active material, a negative electrode, and an alkali metal ion battery.

### BACKGROUND ART

As a negative electrode material for an alkali metal ion battery, generally, a graphite material is used. However, in the graphite material, the space between crystallite layers expands and contracts depending on doping/undoping of an alkali metal ion such as lithium, crystallites are easily distorted. Therefore, in the graphite material, the crystal structure is likely to break due to repetition of charging and discharging, and an alkali metal ion battery in which the graphite material is used as a negative electrode material has poor charging and discharging cycle characteristics.

Patent Document 1 (Japanese Unexamined Patent Publication No. 8-115723) describes a carbonaceous material for a rechargeable battery electrode in which the average layer plane spacing of a (002) plane obtained using an X-ray diffraction method is 0.365 nm or greater, and the ratio (ρ_{H}/ρ_{B}) of the density (ρ_{H}) measured using helium gas as a substitution medium to the density (ρ_{B}) measured using butanol as a substitution medium is 1.15 or greater.

In this carbonaceous material, the spacing between crystallite layers is wider than that of a graphite material, and, compared with a graphite material, the crystal structure does not easily break due to repetition of charging and discharging, and thus charging and discharging cycle characteristics are excellent (refer to Patent Documents 1 and 2).

### RELATED DOCUMENTS

### Patent Documents

[Patent Document 1] Japanese Unexamined Patent Publication No. 8-115723

[Patent Document 2] International Patent Publication No. WO2007/040007

### SUMMARY OF THE INVENTION

However, the carbonaceous material having a greater spacing between crystallite layers than a graphite material as described in Patent Document 1 more easily deteriorates in the atmosphere and has poorer storage characteristics than a graphite material. Therefore, the carbonaceous material needs to be stored in an inert gas atmosphere or the like immediately after production, and it is more difficult to handle the carbonaceous material than a graphite material.

Generally, a negative electrode material having a greater d₀₀₂ than a graphite material has more fine pores than a graphite material, and thus moisture is easily adsorbed to the inside of the fine pores. When moisture is adsorbed thereto, an irreversible reaction is caused between lithium doped into the negative electrode material and the moisture, and consequently, the irreversible capacity during initial charging increases or charging and discharging cycle characteristics degrade. For the above-described reason, it has been considered that a negative electrode material having a great d₀₀₂ has poorer storage characteristics than a graphite material (for example, refer to Patent Document 2). Therefore, in the related art, an attempt has been made to improve storage characteristics by closing fine pores in a negative electrode material and thus decreasing the equilibrium moisture adsorption amount (for example, refer to Patent Document 2).

However, in spite of the present inventors' attempt to revitalize a negative electrode material by heating and drying a deteriorated negative electrode material so as to remove moisture adsorbed to the insides of fine pores, it was not possible to fully revitalize the negative electrode material. In addition, as described in Patent Document 2, there has been another problem in that, when fine pores in the negative electrode are closed, the charge and discharge capacity decreases.

Therefore, an object of the present invention is to provide a negative electrode material for an alkali metal ion battery which has a greater average layer plane spacing of a (002) plane than a graphite material and is excellent in terms of storage characteristics and the charge and discharge capacity.

According to the present invention, there is provided a negative electrode material which is a carbonaceous negative electrode material used for an alkali metal ion battery, in which an average layer plane spacing d₀₀₂ of a (002) plane obtained using an X-ray diffraction method in which a CuKα ray is used as a radiation source is 0.340 nm or greater, and, when a cross section of the negative electrode material is exposed by cutting and polishing a cured substance obtained by embedding the negative electrode material in an epoxy resin and curing the epoxy resin, the cross section includes a first region and a second region having different hardness values measured by means of micro-hardness measurement.

According to the present invention, there is provided a negative electrode material which is a carbonaceous negative electrode material used for an alkali metal ion battery, in which an average layer plane spacing d₀₀₂ of a (002) plane obtained using an X-ray diffraction method in which a CuKα ray is used as a radiation source is 0.340 nm or greater, and, when a cross section of the negative electrode material is exposed by cutting and polishing a cured substance obtained by embedding the negative electrode material in an epoxy resin and curing the epoxy resin, the cross section includes a first region and a second region having different intensities of a peak, which corresponds to a lattice constant of graphite, of a curve obtained by means of an image analysis of an electron beam diffraction image observed using a transmission electron microscope.

Furthermore, according to the present invention, there is provided a negative electrode active material including the negative electrode material.

Furthermore, according to the present invention, there is provided a negative electrode including the negative electrode active material.

Furthermore, according to the present invention, there is provided an alkali metal ion battery including at least the negative electrode, an electrolyte, and a positive electrode.

According to the present invention, it is possible to provide a negative electrode material for an alkali metal ion battery which has a greater average layer plane spacing of a (002) plane than a graphite material and is excellent in terms of storage characteristics and the charge and discharge capacity.

### BRIEF DESCRIPTION OF THE DRAWINGS

The above-described object, other objects, characteristics, and advantages will be further clarified using preferred embodiments described below and the accompanying drawings.

FIG. 1 shows schematic views for explaining examples of a cross-sectional structure of a negative electrode material of an embodiment according to the present invention.

FIG. 2 is a schematic view showing an example of a lithium ion battery of an embodiment according to the present invention.

FIG. 3 is a view showing an optical micrograph of a cross section of a negative electrode material obtained in Example 1.

FIG. 4 is a view showing an optical micrograph of a cross section of a negative electrode material obtained in Example 5.

FIG. 5 is a view showing an optical micrograph of a cross section of a negative electrode material obtained in Comparative Example 1.

FIG. 6 is a schematic view of an indentation test.

FIG. 7 is an example of results of the indentation test.

FIG. 8 is an example of curves obtained by means of an image analysis.

FIG. 9 is an example of curves obtained by means of an image analysis.

### DESCRIPTION OF EMBODIMENTS

Hereinafter, embodiments of the present invention will be described using the drawings. Meanwhile, the drawings are schematic views and do not necessarily coincide with actual dimensional ratios.

<Negative Electrode Material>

A negative electrode material 100 according to the present invention is a carbonaceous negative electrode material used for an alkali metal ion battery. In addition, the average layer plane spacing d₀₀₂ (hereinafter, also referred to as “d₀₀₂”) of the (002) plane obtained using an X-ray diffraction method in which a CuKα ray is used as a radiation source is 0.340 nm or greater.

In addition, the negative electrode material 100 satisfies either or both the following (condition A) and (condition B).

(Condition A) When a cross section of the negative electrode material is exposed by cutting and polishing a cured substance obtained by embedding the negative electrode material in an epoxy resin and curing the epoxy resin, the cross section includes a first region and a second region having different hardness values measured by means of micro-hardness measurement.

(Condition B) When a cross section of the negative electrode material is exposed by cutting and polishing a cured substance obtained by embedding the negative electrode material in an epoxy resin and curing the epoxy resin, the cross section includes a first region and a second region having different intensities of a peak, which corresponds to a lattice constant of graphite, of a curve obtained by means of an image analysis of an electron beam diffraction image observed using a transmission electron microscope (hereinafter, also referred to as “the peak intensity corresponding to the lattice constant of graphite”).

The lower limit of the average layer plane spacing d₀₀₂ is 0.340 nm or greater, preferably 0.350 nm or greater, and more preferably 0.365 nm or greater. When the d₀₀₂ is equal to or greater than the above-described lower limit value, the crystal structure being broken due to doping/undoping of an alkali metal ion such as lithium is suppressed, and thus it is possible to improve the charging and discharging cycle characteristics of the negative electrode material 100.

The upper limit of the average layer plane spacing d₀₀₂ is not particularly limited, generally 0.400 nm or lower, preferably 0.395 nm or lower, and more preferably 0.390 nm or lower. When the d₀₀₂ is equal to or lower than the above-described upper limit value, it is possible to suppress the irreversible capacity of the negative electrode material 100.

A carbonaceous material having the above-described average layer plane spacing d₀₀₂ is generally called non-graphitization carbon.

In addition, the negative electrode material 100 satisfies either or both the above-described conditions A and B. When either or both the conditions A and B are satisfied, it is possible to provide excellent storage characteristics and an excellent charge and discharge capacity to the negative electrode material 100.

The reason for the negative electrode material 100 satisfying either or both the conditions A and B having excellent storage characteristics and an excellent charge and discharge capacity in spite of the d₀₀₂ of 0.340 nm or greater is not clear, but it is considered that hardness or crystallinity differs in the first region and the second region, and thus a region contributing to an increase in the capacity and a region contributing to improvement of storage characteristics are formed in an appropriate configuration.

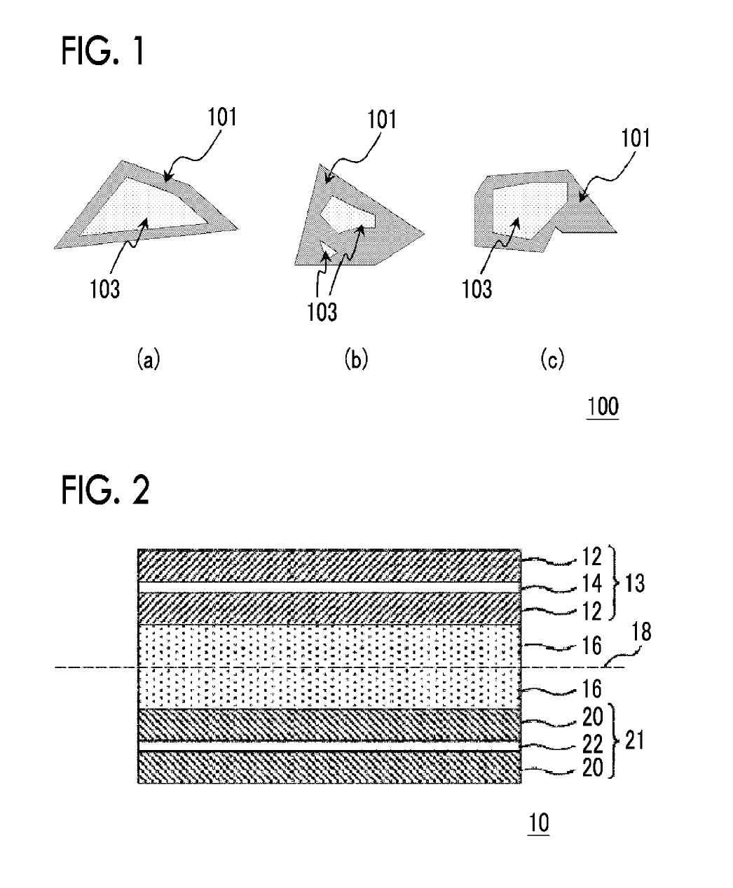

Hereinafter, the conditions A and B will be described in more detail using FIG. 1. FIG. 1 shows schematic views for explaining examples of a cross-sectional structure of the negative electrode material 100 of an embodiment according to the present invention.

As shown in FIGS. 1(a) to 1(c), the negative electrode material 100 includes a first region 101 and a second region 103. In the range of the first region 101, hardness measured by means of micro-hardness measurement and/or the peak intensity corresponding to the lattice constant of graphite are almost constant. In addition, in the range of the second region 103, the hardness and/or the peak intensity corresponding to the lattice constant of graphite are almost constant.

Here, hardness being almost constant means that, for example, the fluctuation range of the hardness measured by means of micro-hardness measurement is ±0.1 GPa or narrower.

In addition, the peak intensity corresponding to the lattice constant of graphite being almost constant means that, for example, the fluctuation range of the measured peak intensity is ±0.01 or narrower.

In addition, as shown in FIGS. 1(a) to 1(c), in the negative electrode material 100, it is preferable that the first region 101 is present along the exterior of the cross section of the negative electrode material 100 and the second region 103 is present inside the first region 101. In a case in which the negative electrode material 100 has the above-described constitution, the negative electrode material has an effect of improving storage characteristics and increasing the charge and discharge capacity.

In the negative electrode material 100, the hardness of the second region 103 measured by means of micro-hardness measurement is preferably greater than the hardness of the first region 101 measured by means of micro-hardness measurement. In this case, the negative electrode material has an effect of improving storage characteristics and increasing the charge and discharge capacity.

Furthermore, in the negative electrode material 100, the peak intensity corresponding to the lattice constant of graphite in the second region 103 is preferably greater than the peak intensity in the first region 101. In this case, the negative electrode material has an effect of improving storage characteristics and increasing the charge and discharge capacity.

The hardness of the second region 103 measured by means of micro-hardness measurement is preferably equal to or higher than 1 GPa and equal to or lower than 7 GPa, more preferably equal to or higher than 2 GPa and equal to or lower than 6 GPa, and particularly preferably equal to or higher than 4 GPa and equal to or lower than 6 GPa. In a case in which the hardness of the second region 103 measured by means of micro-hardness measurement is in the above-described range, the negative electrode material has an effect of improving storage characteristics and increasing the charge and discharge capacity.

The hardness of the first region 101 measured by means of micro-hardness measurement is preferably equal to or higher than 0.1 GPa and equal to or lower than 6 GPa, more preferably equal to or higher than 0.2 GPa and equal to or lower than 5 GPa, and particularly preferably equal to or higher than 0.5 GPa and equal to or lower than 4.5 GPa. In a case in which the hardness of the first region 101 measured by means of micro-hardness measurement is in the above-described range, the negative electrode material has an effect of improving storage characteristics and increasing the charge and discharge capacity.

The modulus of elasticity of the second region 103 measured by means of micro-hardness measurement is preferably equal to or higher than 9 GPa and equal to or lower than 30 GPa, more preferably equal to or higher than 15 GPa and equal to or lower than 29 GPa, and particularly preferably equal to or higher than 18 GPa and equal to or lower than 28 GPa. In a case in which the modulus of elasticity of the second region 103 measured by means of micro-hardness measurement is in the above-described range, the negative electrode material has an effect of improving storage characteristics and increasing the charge and discharge capacity.

In addition, in the negative electrode material 100, when a cross section of the negative electrode material 100 is exposed by cutting and polishing a cured substance obtained by embedding the negative electrode material 100 in an epoxy resin and curing the epoxy resin, and then a bright field of the cross section is observed at a magnification of 1000 times using an optical microscope, in the cross section, the first region 101 and the second region 103 having different reflectivity values are observed.

The negative electrode material 100 in which the first region 101 and the second region 103 having different reflectivity values are observed has excellent storage characteristics and an excellent charge and discharge capacity.

Hereinafter, the first region 101 and the second region 103 having different reflectivity values will be described in more detail using FIG. 1.

FIG. 1 shows schematic views for explaining examples of a cross-sectional structure of the negative electrode material 100 of the embodiment according to the present invention.

As shown in FIGS. 1(a) to 1(c), the negative electrode material 100 has almost constant reflectivity in the first region 101 and the second region 103 respectively, and the reflectivity discontinuously changes in the interface between the first region 101 and the second region 103.

In addition, in the negative electrode material 100, as shown in FIGS. 1(a) to 1(c), for example, the first region 101 is present along the exterior of the cross section of the negative electrode material 100 and the second region 103 is present inside the first region 101.

Furthermore, in the negative electrode material 100, for example, the reflectivity (B) of the second region 103 is greater than the reflectivity (A) of the first region 101. That is, when observed using an optical microscope, the second region 103 is observed to be more whitish (brighter) than the first region 101.

The reason for the negative electrode material 100 in which the first region 101 and the second region 103 having different reflectivity values are observed as described above having excellent storage characteristics and an excellent charge and discharge capacity in spite of the d₀₀₂ of 0.340 nm or greater is not clear, but it is considered that a region contributing to an increase in the capacity and a region contributing to improvement of storage characteristics are formed in an appropriate configuration.

The negative electrode material 100 is used as the negative electrode material 100 for an alkali metal ion battery such as a lithium ion battery or a sodium ion battery. Particularly, the negative electrode material 100 is preferably used as a negative electrode material for a lithium ion battery.

(Amount of Moisture by Means of Karl Fischer Coulometric Titration)

In the negative electrode material 100, when moisture generated after the negative electrode material 100 is preliminarily dried by holding the negative electrode material 100 under conditions of a temperature of 40° C. and a relative humidity of 90% RH for 120 hours and then holding the negative electrode material 100 under conditions of a temperature of 130° C. and a nitrogen atmosphere for one hour, and then the preliminarily dried negative electrode material 100 is held at 200° C. for 30 minutes is measured by means of the Karl Fischer coulometric titration, the amount of moisture generated from the preliminarily dried negative electrode material 100 is preferably 0.20% by mass or lower, more preferably 0.15% by mass or lower, and particularly preferably 0.10% by mass or lower with respect to 100% by mass of the preliminarily dried negative electrode material 100.

When the amount of moisture is the above-described upper limit value or lower, it is possible to further suppress deterioration of the negative electrode material 100 even when the negative electrode material 100 is stored in the atmosphere for a long period of time. Meanwhile, the amount of moisture refers to an index of the adsorption amount of chemisorbed water desorbed when the negative electrode material 100 is held at 200° C. for 30 minutes.

The lower limit of the moisture amount is not particularly limited, and is generally 0.01% by mass or higher.

The reason for deterioration of the negative electrode material 100 being further suppressed when the amount of moisture measured by means of Karl Fischer coulometric titration is the above-described upper limit value or lower is not clear, but it is considered that, as the amount of moisture decreases in the negative electrode material 100, adsorption of moisture becomes more difficult in the structure.

According to the present inventors' studies, it has been clarified that moisture adsorbed to the negative electrode material 100 can be roughly classified into physisorbed water and chemisorbed water, and, as the adsorption amount of chemisorbed water decreases in the negative electrode material 100, storage characteristics become more excellent, and the charge and discharge capacity becomes more excellent. That is, it has been found that a criterion called the adsorption amount of chemisorbed water is an effective design index for realizing the negative electrode material 100 having excellent storage characteristics and an excellent charge and discharge capacity.

Here, the physisorbed water refers to adsorbed water which is physically present mainly in a water molecule form on the surface of the negative electrode material 100. On the other hand, the chemisorbed water refers to adsorbed water which is coordinated or chemically bonded to a first layer on the surface of the negative electrode material 100.

The negative electrode material 100 having a small adsorption amount of chemisorbed water is considered to have a structure in which the surface of the negative electrode material 100 does not easily allow moisture to be coordinated or chemically bonded thereto or a structure which is not easily changed to the above-described structure even when the negative electrode material is left in the atmosphere. Therefore, when the amount of moisture is the above-described upper limit value or lower, moisture is not easily adsorbed to the negative electrode material or the surface structure does not easily change even when the negative electrode material is stored in the atmosphere for a long period of time, and thus storage characteristic is considered to be superior.

Meanwhile, in the present embodiment, moisture desorbed from the negative electrode material 100 during the preliminary drying in which the negative electrode material is held under conditions of a temperature of 130° C. and a nitrogen atmosphere for one hour will be referred to as physisorbed water, and water desorbed from the negative electrode material 100 in the operation in which the preliminarily dried negative electrode material 100 is held at a temperature of 200° C. for 30 minutes will be referred to as chemisorbed water.

(Size of Crystallite)

In the negative electrode material 100, the size of a crystallite in a c axis direction, which is measured by means of an X-ray diffraction method, (hereinafter, in some cases, abbreviated as “Lc₍₀₀₂₎”) is preferably 5 nm or smaller, more preferably 3 nm or smaller, and still more preferably 2 nm or smaller.

(Mean Particle Diameter)

The negative electrode material 100 generally has a particulate shape.

In the negative electrode material 100, the particle diameter at which accumulation reaches 50% in the volume-based cumulative distribution (D₅₀, mean particle diameter) is preferably equal to or larger than 1 μm and equal to or smaller than 50 μm and more preferably equal to or larger than 2 μm and equal to or smaller than 30 μm. In such a case, it is possible to produce a high-density negative electrode.

(Specific Surface Area)

In the negative electrode material 100, the specific surface area by means of a BET 3-point method in nitrogen adsorption is preferably equal to or larger than 1 m²/g and equal to or smaller than 15 m²/g and more preferably equal to or larger than 3 m²/g and equal to or smaller than 8 m²/g.

When the specific surface area by means of the BET 3-point method in nitrogen adsorption is the above-described upper limit value or lower, it is possible to further suppress an irreversible reaction between the negative electrode material 100 and an electrolytic solution.

In addition, when the specific surface area by means of the BET 3-point method in nitrogen adsorption is the above-described lower limit value or higher, it is possible to obtain appropriate permeability of an electrolytic solution in the negative electrode material 100.

A method for computing the specific surface area is as described below.

The monomolecular layer adsorption amount Wₘ is computed using Expression (1) below, the total surface area Sₜₒₜₐₗ is computed using Expression (2) below, and the specific surface area S is obtained using Expression (3) below.

1/[W·{(Pₒ/P)−1}]={(C−1)/(Wₘ·C)}(P/Pₒ)(1/(Wₘ·C)) (1)

In Expression (1), P: the pressure of a gaseous adsorbate at the adsorption equilibrium, Pₒ: the saturated vapor pressure of an adsorbate at the adsorption temperature, W: the adsorption amount at the adsorption equilibrium pressure P, Wₘ: the adsorption amount of a monomolecular layer, C: a constant relating to the intensity of an interaction between a solid surface and an adsorbate (C=exp{(E₁−E₂)RT}) [E₁: the adsorption heat of the first layer (kJ/mol), E₂: the heat of liquefaction at a measurement temperature of an adsorbate (kJ/mol)]

Sₜₒₜₐₗ=(WₘNA_{CS})M (2)

In Expression (2), N: Avogadro's number, M: molecular weight, A_{CS}: adsorption cross-sectional area

S=Sₜₒₜₐₗ/w (3)

In Expression (3), w: the weight of a sample (g)

(Adsorption Amount of Carbonate Gas)

The upper limit value of the adsorption amount of carbonate gas in the negative electrode material 100 is preferably lower than 10 ml/g, more preferably lower than 8.5 ml/g, and still more preferably lower than 6.5 ml/g. In a case in which the adsorption amount of carbonate gas is lower than the above-described upper limit value, it is possible to further improve the storage characteristics of the negative electrode material 100.

In addition, the lower limit value of the adsorption amount of carbonate gas of the negative electrode material 100 is preferably 0.05 ml/g or higher and more preferably 0.1 ml/g or higher. In a case in which the lower limit value of the adsorption amount of carbonate gas is the above-described lower limit value or higher, it is possible to further improve the charge capacity.

Meanwhile, the adsorption amount of carbonate gas can be measured using an ASAP-2000M manufactured by Micromeritics Instrument Corporation after a measurement specimen is produced by drying the negative electrode material 100 in a vacuum at 130° C. for three or more hours using a vacuum dryer.

(ρ^{H}/ρ^{B})

In the negative electrode material 100, the ratio (ρ^{H}/ρ^{B}) of the density (ρ^{H}) measured using helium gas as a substitution medium to the density (ρ^{B}) measured using butanol as a substitution medium is preferably greater than 1.05, more preferably 1.07 or greater, and still more preferably 1.09 or greater.

In addition, ρ^{H}/ρ^{B} is preferably lower than 1.25, more preferably lower than 1.20, and still more preferably lower than 1.15.

When the ρ^{H}/ρ^{B} is the above-described lower limit value or higher, it is possible to further improve the charge capacity of lithium. In addition, when the ρ^{H}/ρ^{B} is the above-described upper limit value or lower, it is possible to further decrease the irreversible capacity of lithium.

The ρ^{H}/ρ^{B} value is one index of the fine pore structure of the negative electrode material 100, and it means that, as this value increases, the number of fine pores which are too small for butanol to enter, but are large enough for helium to enter. That is, a large ρ^{H}/ρ^{B} means the presence of a large number of fine pores. In addition, when a large number of fine pores that are too small even for helium to enter are present, ρ^{H}/ρ^{B} decreases.

In addition, in the negative electrode material 100, ρ^{B} is preferably equal to or higher than 1.50 g/cm³ and equal to or lower than 1.80 g/cm³, more preferably equal to or higher than 1.55 g/cm³ and equal to or lower than 1.78 g/cm³, and still more preferably equal to or higher than 1.60 g/cm³ and equal to or lower than 1.75 g/cm³ from the viewpoint of controlling the fine pore size.

In addition, in the negative electrode material 100, ρ^{H} is preferably equal to or higher than 1.80 g/cm³ and equal to or lower than 2.10 g/cm³, more preferably equal to or higher than 1.85 g/cm³ and equal to and lower than 2.05 g/cm³, and still more preferably equal to or higher than 1.88 g/cm³ and equal to or lower than 2.00 g/cm³ from the viewpoint of controlling the fine pore size.

(Volume of Fine Pores)

In the negative electrode material 100, the volume of fine pores having a fine pore diameter, which is obtained using a mercury press-in method, in a range of 0.003 μm to 5 μm is preferably lower than 0.55 ml/g, more preferably 0.53 ml/g or lower, and still more preferably 0.50 ml/g or lower from the viewpoint of improving the packing density.

In addition, in the negative electrode material 100, the volume of fine pores having a fine pore diameter, which is obtained using a mercury press-in method, in a range of 0.003 μm to 5 μm is preferably 0.10 ml/g or higher, more preferably 0.20 ml/g or higher, and still more preferably 0.30 ml/g or higher from the viewpoint of decreasing the irreversible capacity.

Here, the volume of fine pores obtained by means of the mercury press-in method can be measured using an AUTOPORE III9420 manufactured by Micrometrics.

(Discharge Capacity)

In the negative electrode material 100, when a half-cell produced under conditions described below is charged and discharged under charging and discharging conditions described below, the discharge capacity is preferably 360 mAh/g or higher, more preferably 380 mAh/g or higher, still more preferably 400 mAh/g or higher, and particularly preferably 420 mAh/g or higher. The upper limit of the discharge capacity is not particularly limited and is preferably higher. The upper limit thereof is realistically 700 mAh/g or lower and is generally 500 mAh/g or lower. Meanwhile, in the present specification, “mAh/g” represents the capacity of the negative electrode material 100 per gram.

(Conditions for Producing Half-Cell)

The conditions for producing the half-cell will be described.

As a negative electrode, a negative electrode formed of the negative electrode material 100 is used. More specifically, an electrode formed of an electrode using a composition obtained by mixing the negative electrode material 100, carboxymethyl cellulose, styrene/butadiene rubber, and acetylene black in a ratio of 100:1.5:3.0:2.0 in terms of the weight ratio is used.

As the counter electrode, metallic lithium is used.

As an electrolytic solution, an electrolytic solution obtained by dissolving LiPF₆ in a carbonate-based solvent (a solvent mixture obtained by mixing ethylene carbonate and diethyl carbonate in a volume ratio of 1:1) in a ratio of 1 M is used.

The above-described negative electrode can be produced as described below.

First, a predetermined amount of the negative electrode material 100, carboxymethyl cellulose, styrene/butadiene rubber, acetylene black, and water are stirred and mixed together, thereby preparing a slurry. The obtained slurry is applied onto a copper foil which is a collector, is preliminarily dried at 60° C. for two hours, and then is dried in a vacuum at 120° C. for 15 hours. Next, the copper foil is cut into a predetermined size, whereby it is possible to obtain a negative electrode constituted with the negative electrode material 100.

In addition, the negative electrode can be formed into a disc shape having a diameter of 13 mm, a negative electrode active material layer (a portion obtained by removing the collector from the negative electrode) can be formed into a disc shape having a thickness of 50 μm, and the counter electrode (an electrode constituted with metallic lithium) can be formed into a disc shape having a diameter of 12 mm and a thickness of 1 mm.

In addition, the shape of the half-cell can be the shape of a 2032 coin cell.

(Charging and Discharging Conditions)

The conditions for charging and discharging the half-cell are as described below.

Measurement temperature: 25° C.

Charging method: a constant current and constant voltage method, charge current: 25 mA/g, charge voltage: 0 mV, end-of-charge current: 2.5 mA/g

Discharging method: a constant current method, discharge current: 25 mA/g, end-of-discharge voltage: 2.5 V

Meanwhile, for the half-cell, “charging” refers to migration of lithium ions from an electrode constituted with metallic lithium to an electrode constituted with the negative electrode material 100 by applying a voltage. “Discharging” refers to a phenomenon in which lithium ions migrate from an electrode constituted with the negative electrode material 100 to an electrode constituted with metallic lithium.

<Method for Manufacturing Negative Electrode Material 100>

Next, a method for manufacturing the negative electrode material 100 will be described.

The negative electrode material 100 can be manufactured by, for example, carbonizing a specific resin composition as a raw material under appropriate conditions.

Even in the related art, a negative electrode material can be manufactured using a resin composition as a raw material. However, in the present embodiment, factors such as (1) the composition of the resin composition, (2) the conditions of the carbonization treatment, and (3) the occupancy proportion of the raw material in a space for the carbonization treatment are controlled in a highly precise fashion. In order to obtain the negative electrode material 100, it becomes important to control these factors in a highly precise fashion.

Particularly, the present inventors found that, in order to obtain the negative electrode material 100 according to the present embodiment, it is important to appropriately set the conditions of (1) and (2) and then set (3) the occupancy proportion of the raw material in the space for the carbonization treatment to be lower than the standard of the related art.

Hereinafter, an example of the method for manufacturing the negative electrode material 100 will be described. However, the method for manufacturing the negative electrode material 100 is not limited to the following example.

(Resin Composition)

In the beginning, (1) as a raw material of the negative electrode material 100, a resin composition to be carbonized is selected.

Examples of a resin included in the resin composition which serves as the raw material of the negative electrode material 100 include a thermosetting resin; a thermoplastic resin; petroleum-based or coal-based tar or pitch such as petroleum-based tar or pitch generated as a byproduct during the manufacturing of ethylene, coal tar generated during drying of coal, a heavy component or pitch obtained by removing a low-boiling point component by means of distillation from coal tar, or tar or pitch obtained by means of liquefaction of coal; furthermore, crosslinked tar or pitch; a natural polymer substance such as a coconut husk or timber; and the like. These resins can be used singly or in a form of a mixture of two or more resins. Among these, a thermosetting resin is preferred since the thermosetting resin can be purified as a raw material, can be used to produce a negative electrode material including a small amount of impurities, and can be purified using a step that can be significantly shortened and thus reduce costs.

Examples of the thermosetting resin include phenol resins such as a novolac-type phenol resin and a resole-type phenol resin; epoxy resins such as a bisphenol-type epoxy resin and a novolac-type epoxy resin; melamine resins; urea resins; aniline resins; cyanate resins; furan resins; ketone resins; unsaturated polyester resins; urethane resins; and the like. In addition, it is also possible to use modified substances obtained by modifying the thermosetting resin with a variety of components.

Among these, phenol resins such as a novolac-type phenol resin and a resole-type phenol resin, melamine resins; urea resins; and aniline resins which are resins for which formaldehyde is used are preferred due to their high residual carbon ratio.

In addition, in a case in which the thermosetting resin is used, it is possible to jointly use a curing agent therefor.

As the curing agent used, for example, in the case of the novolac-type phenol resin, it is possible to use hexamethylenetetramine, a resole-type phenol resin, polyacetal, paraformaldehyde, or the like. In the case of the resole-type phenol resin, the melamine resin, the urea resin, and the aniline resin, it is possible to use hexamethylenetetramine or the like.

The amount of the curing agent blended is generally equal to or larger than 0.1 parts by mass and equal to or smaller than 50 parts by mass with respect to 100 parts by mass of the thermosetting resin.

In addition, into the resin composition which serves as a raw material of the negative electrode material 100, it is possible to blend additives in addition to the thermosetting resin and the curing agent.

The additives used herein are not particularly limited, and examples thereof include carbon material precursors that are carbonized at a temperature that is equal to or higher than 200° C. and equal to or lower than 800° C., organic acids, inorganic acids, nitrogen-containing compounds, oxygen-containing compounds, aromatic compounds, non-ferrous metals, and the like. These additives can be used singly or in a form of a mixture of two or more additives depending on the kind, properties, and the like of the resin being used.

A method for preparing the resin composition is not particularly limited, and the resin composition can be prepared using, for example, (1) a method in which the resin and other components are melted and mixed together, (2) a method in which the resin and other components are dissolved and mixed together in a solvent, (3) a method in which the resin and other components are crushed and mixed together, or the like.

An apparatus for preparing the resin composition is not particularly limited, and, for example, in a case in which the resin and other components are melted and mixed together, a kneading apparatus such as a kneading roll or a uniaxial or biaxial kneader can be used. In a case in which the resin and other components are dissolved and mixed together, a mixing apparatus such as a Henschel mixer or a disperser can be used. In a case in which the resin and other components are crushed and mixed together, for example, an apparatus such as a hammer mill or a jet mill can be used.

The resin composition obtained in the above-described fashion may be a resin composition obtained simply by physically mixing a plurality of kinds of components or a resin composition obtained by chemically reacting some of the resin composition using a mechanical energy imparted during mixing (stirring, kneading, or the like) and a heat energy converted from the mechanical energy during the preparation of the resin composition. Specifically, the resin composition may be mechanochemically reacted using a mechanical energy or chemically reacted using a heat energy.

(Carbonization Treatment)

Next, the obtained resin composition is carbonized.

Here, regarding the conditions for the carbonization treatment, the resin composition can be carbonized by, for example, heating the resin composition from room temperature at a rate that is equal to or higher than 1° C./hour and equal to or lower than 200° C./hour and holding the resin composition at a temperature that is equal to or higher than 800° C. and equal to or lower than 3000° C. and a pressure that is equal to or higher than 0.01 Pa and equal to or lower than 101 kPa (1 atmosphere) for equal to or longer than 0.1 hours and equal to or shorter than 50 hours, preferably, for equal to or longer than 0.5 hours and equal to or shorter than 10 hours. Regarding the atmosphere during the carbonization treatment, the resin composition is preferably carbonized in an atmosphere of an inert gas such as nitrogen or helium gas; in a substantially inert atmosphere in which a small amount of oxygen is present in an inert gas; a reducing gas atmosphere; or the like. In such a case, it is possible to suppress thermal decomposition (oxidation and decomposition) of the resin and obtain a desired negative electrode material 100.

The above-described conditions during the carbonization treatment such as temperature and duration can be appropriately adjusted in order to optimize the characteristics of the negative electrode material 100.

Meanwhile, before the carbonization treatment, a pre-carbonization treatment may be carried out.

Here, the conditions of the pre-carbonization treatment are not particularly limited, and it is possible to carry out the pre-carbonization treatment, for example, at a temperature that is equal to or higher than 200° C. and equal to or lower than 1000° C. for equal to or longer than 1 hour and equal to or shorter than 10 hours. When the pre-carbonization treatment is carried out before the carbonization treatment as described above, the melting of the resin composition is prevented, and, even in a case in which a crushing treatment of the resin composition or the like is carried out before a carbonation treatment step, re-fusion of the crushed resin composition or the like during the carbonization treatment is prevented, and a desired negative electrode material 100 can be efficiently obtained.

In addition, before the pre-carbonization treatment, a curing treatment of the resin composition may be carried out.

A method for the curing treatment is not particularly limited, and the curing treatment can be carried out using, for example, a method in which an amount of heat capable of causing a curing reaction is imparted to the resin composition, thereby thermally curing the resin composition, a method in which a thermosetting resin and a curing agent are jointly used, or the like. In such a case, since the pre-carbonization treatment can be carried out on a substantially solid phase, it is possible to carry out the carbonization treatment or the pre-carbonization treatment while maintaining the structure of the thermosetting resin to a certain extent, and the structure or characteristics of the negative electrode material can be controlled.

Meanwhile, in a case in which the carbonization treatment or the pre-carbonization treatment is carried out, it is also possible to impart desired characteristics to the negative electrode material 100 by adding metal, a pigment, a lubricant, an antistatic agent, an antioxidant, or the like to the resin composition.

In a case in which the curing treatment or the pre-carbonization treatment is carried out, the treated substance may be crushed after the treatment and before the carbonization treatment. In such a case, the fluctuation of the thermal history during the carbonization treatment is reduced, and the uniformity of the surface state of the obtained negative electrode material 100 can be increased. In addition, it is possible to improve the handling properties of the treated substance.

(Occupancy Proportion of Raw Material in Space for Carbonization Treatment)

In addition, in order to obtain the negative electrode material 100, it is important to appropriately adjust the occupancy proportion of the raw material in a space for the carbonization treatment. Specifically, the occupancy proportion of the raw material in a space for the carbonization treatment is preferably set to 10.0 kg/m³ or lower, more preferably set to 5.0 kg/m³ or lower, and particularly preferably set to 1.0 kg/m³ or lower. Here, the space for the carbonization treatment refers to the in-furnace volume of a thermal treatment furnace that is generally used for a carbonization treatment.

Meanwhile, the standard of the occupancy proportion of the raw material in a space for the carbonization treatment in the related art is in a range of approximately 100 kg/m³ to 500 kg/m³. Therefore, in order to obtain the negative electrode material 100, it is important to set the occupancy proportion of the raw material in a space for the carbonization treatment to be lower than the standard of the related art.

The reason why the negative electrode material 100 can be obtained by setting the occupancy proportion of the raw material in a space for the carbonization treatment to the above-described upper limit value or lower is not clear, but the reason is considered to have a relationship with efficient removal of gas generated from the raw material (the resin composition) during the carbonization treatment to the outside.

In the above-described order, the negative electrode material 100 according to the present embodiment can be obtained. Meanwhile, generally, the negative electrode material 100 can be obtained by carbonizing a single resin composition.

<Negative Electrode Active Material>

Hereinafter, a negative electrode active material according to the present embodiment will be described.

The negative electrode active material refers to a substance allowing outputting or inputting of alkali metal ions such as lithium ions in an alkali metal ion battery. The negative electrode active material according to the present embodiment includes the above-described negative electrode material 100.

The negative electrode active material according to the present embodiment may further include a negative electrode material that is different type from the above-described negative electrode material 100. Examples of the negative electrode material include ordinarily well-known negative electrode materials such as silicon, silicon monoxide, and graphite materials.

Among these, the negative electrode active material according to the present embodiment preferably includes a graphite material in addition to the above-described negative electrode material 100. In such a case, it is possible to improve the charge and discharge capacity of the obtained alkali metal ion battery. Therefore, it is possible to provide a particularly excellent balance between a charge and discharge capacity and a charge and discharge efficiency in the obtained alkali metal ion battery.

In the graphite material being used, the particle diameter at which accumulation reaches 50% in the volume-based cumulative distribution (mean particle diameter) is preferably equal to or larger than 2 μm and equal to or smaller than 50 μm and more preferably equal to or larger than 5 μm and equal to or smaller than 30 μm. In such a case, it is possible to produce a high-density negative electrode while maintaining a high charge and discharge efficiency.

The content of the negative electrode material 100 in the negative electrode active material according to the present embodiment is preferably 50% by mass or more, more preferably 75% by mass or more, still more preferably 80% by mass or more, and particularly preferably 90% by mass or more when the total amount of the negative electrode active material is considered to be 100% by mass. In such a case, it is possible to provide an alkali metal ion battery having superior storage characteristics and a superior charge and discharge capacity.

<Negative Electrode for Alkali Metal Ion Battery and Alkali Metal Ion Battery>

Hereinafter, a negative electrode for an alkali metal ion battery and an alkali metal ion battery according to the present embodiment will be described.

The negative electrode for an alkali metal ion battery according to the present embodiment (hereinafter, in some cases, simply referred to as the negative electrode) is manufactured using the above-described negative electrode active material according to the present embodiment. In such a case, it is possible to provide a negative electrode having excellent storage characteristics and an excellent charge and discharge capacity.

In addition, the alkali metal ion battery according to the present embodiment is manufactured using the above-described negative electrode according to the present embodiment. In such a case, it is possible to provide an alkali metal ion battery having excellent storage characteristics and an excellent charge and discharge capacity.

The alkali metal ion battery according to the present embodiment is, for example, a lithium ion battery or a sodium ion battery. Hereinafter, a case of a lithium ion battery will be described as an example.

FIG. 2 is a schematic view showing an example of a lithium ion battery according to the present embodiment.

A lithium ion battery 10 includes a negative electrode 13, a positive electrode 21, an electrolytic solution 16, and a separator 18 as shown in FIG. 2.

The negative electrode 13 includes a negative electrode active material layer 12 and a negative electrode collector 14 as shown in FIG. 2.

The negative electrode collector 14 is not particularly limited, an ordinarily well-known collector for a negative electrode can be used, and it is possible to use, for example, a copper foil, a nickel foil, or the like.

The negative electrode active material layer 12 is constituted with the above-described negative electrode active material according to the present embodiment.

The negative electrode 13 can be manufactured, for example, in the following fashion.

Equal to or more than 1 Part by weight and equal to or less than 30 parts by weight of an ordinarily well-known organic polymer binder (for example, a fluorine-based polymer such as polyvinylidene fluoride or polytetrafluoroethylene; a rubber-form polymer such as styrene/butadiene rubber, butyl rubber, or butadiene rubber; or the like) and an appropriate amount of a solvent for viscosity adjustment (N-methyl-2-pyrolidone, dimethylformamide, or the like) or water are added to 100 parts by weight of the above-described negative electrode active material and the components are kneaded together, thereby preparing a negative electrode slurry.

The negative electrode active material layer 12 can be obtained by molding the obtained slurry into a sheet shape, a pellet shape, or the like by means of compression molding, roll molding, or the like. In addition, the negative electrode active material layer 12 obtained as described above and the negative electrode collector 14 are laminated together, whereby the negative electrode 13 can be obtained.

In addition, the negative electrode 13 can also be manufactured by applying and drying the obtained negative electrode slurry on the negative electrode collector 14.

The electrolytic solution 16 is used to fill a gap between the positive electrode 21 and the negative electrode 13 and is a layer in which lithium ions migrate.

The electrolytic solution 16 is not particularly limited, an ordinarily well-known electrolytic solution can be used, and, it is possible to use, for example, an electrolytic solution obtained by dissolving a lithium salt which serves as an electrolyte in a non-waterborne solvent.

As the non-waterborne solvent, it is possible to use, for example, a cyclic ester such as propylene carbonate, ethylene carbonate, or γ-butyrolactone; a chain-like ester such as dimethyl carbonate or diethyl carbonate; a chain-like ether such as dimethoxyethane; or a mixture thereof.

The electrolyte is not particularly limited, an ordinarily well-known electrolyte can be used, and it is possible to use, for example, a lithium metal salt such as LiClO₄ or LiPF₆. In addition, it is also possible to use a mixture of the above-described salt with polyethylene oxide, polyacrylonitrile, or the like as a solid electrolyte.

The separator 18 is not particularly limited, an ordinarily well-known separator can be used, and it is possible to use, for example, a porous film such as polyethylene or polypropylene, a non-woven fabric, or the like.

The positive electrode 21 includes a positive electrode active material layer 20 and a positive electrode collector 22 as shown in FIG. 2.

The positive electrode active material layer 20 is not particularly limited and can be formed of an ordinarily well-known positive electrode active material. The positive electrode active material is not particularly limited, and it is possible to use, for example, a complex oxide such as lithium cobalt oxide (LiCoO₂), lithium nickel oxide (LiNiO₂), or lithium manganese oxide (LiMn₂O₄); a conductive polymer such as polyaniline or polypyrrole; or the like.

The positive electrode collector 22 is not particularly limited, an ordinarily well-known positive electrode collector can be used, and it is possible to use, for example, an aluminum foil.

In addition, the positive electrode 21 can be manufactured using an ordinary well-known method for manufacturing a positive electrode.

Hitherto, the embodiments of the present invention have been described, but these are examples of the present invention, and it is also possible to employ a variety of constitutions other than the above-described constitution.

In addition, the present invention is not limited to the above-described embodiments, and modified or improved aspects of the present invention are also included in the scope of the present invention as long as the object of the present invention can be achieved.

### EXAMPLES

Hereinafter, the present invention will be described using examples and comparative examples, but the present invention is not limited thereto. Meanwhile, in the examples, “parts” refers to “parts by weight”.

[1] Method for Evaluating Negative Electrode Material

In the beginning, a method for evaluating negative electrode materials obtained in examples and comparative examples described below will be described.

1. Particle Size Distribution

The particle size distribution of a negative electrode material was measured by means of a laser diffraction method using a laser diffraction-type particle size distribution measurement instrument LA-920 manufactured by Horiba, Ltd. From the measurement result, the particle diameter in the negative electrode material at which accumulation reached 50% in the volume-based cumulative distribution (D₅₀, mean particle diameter) was obtained.

2. Specific Surface Area

The specific surface area was measured by means of a BET 3-point method in nitrogen adsorption using a Nova-1200 apparatus manufactured by GS Yuasa Corporation. A specific computation method is as described above.

3. d₀₀₂ and Lc₍₀₀₂₎ of Negative Electrode Material

The average layer plane spacing d₀₀₂ of a (002) plane was measured using an X-ray diffraction apparatus “XRD-7000” manufactured by Shimadzu Corporation.

The average layer plane spacing d₀₀₂ of a (002) plane was computed from a spectrum obtained by means of an X-ray diffraction measurement of the negative electrode material using Bragg's Expression below.

λ=2dₕₖₗ sin θ Bragg's Expression (dₕₖₗ=d₀₀₂)

λ: The wavelength of a characteristic X-ray K_{α1} output from a cathode

θ: The reflection angle of a spectrum

In addition, Lc₍₀₀₂₎ was measured in the following fashion.

Lc₍₀₀₂₎ was determined from the half bandwidth and diffraction angle of the peak of a (002) plane in a spectrum obtained by means of an X-ray diffraction measurement using Scherrer's Expression below.

Lc₍₀₀₂₎=0.94λ/(β cos θ) (Scherrer's Expression)

Lc₍₀₀₂₎: The size of a crystallite

λ: The wavelength of a characteristic X-ray K_{α1} output from a cathode

β: The half bandwidth of the peak (radian)

θ: The reflection angle of a spectrum

4. Adsorption Amount of Carbonate Gas

The adsorption amount of carbonate gas was measured using an ASAP-2000M manufactured by Micromeritics Instrument Corporation after a measurement specimen was produced by drying the negative electrode material in a vacuum at 130° C. for three or more hours using a vacuum dryer.

The measurement specimen (0.5 g) was put into a specimen tube for measurement and was dried at 300° C. for three or more hours under a reduced pressure of 0.2 Pa or lower, and then the adsorption amount of carbonate gas was measured.

The adsorption temperature was set to 0° C., the pressure in the specimen tube including the measurement specimen was reduced to 0.6 Pa or lower, then, carbonate gas was introduced into the specimen tube, the amount of carbonate gas adsorbed until the equilibrium pressure in the specimen tube reached 0.11 MPa (corresponding to a relative pressure of 0.032) was obtained using a constant volume method and was expressed in a unit of ml/g. The adsorption amount is an equivalent value at a standard-state pressure (STP).

5. Measurement of Amount of Moisture by Means of Karl Fischer Coulometric Titration

The amount of moisture by means of the Karl Fischer coulometric titration was measured in the following sequence.

(Sequence 1) The negative electrode material (1 g) was held in an apparatus of a small-sized environment tester (SH-241 manufactured by ESPEC Corp.) for 120 hours under conditions of a temperature of 40° C. and a relative humidity of 90% RH. Meanwhile, the negative electrode material was left to stand in the apparatus in a state of being spread to be as thin as possible in a container having a length of 5 cm, a width of 8 cm, and a height of 1.5 cm.

(Sequence 2) The negative electrode material was preliminarily dried by being held under conditions of a temperature of 130° C. and a nitrogen atmosphere for one hour, and then moisture generated after holding the preliminarily dried negative electrode material at a temperature of 200° C. for 30 minutes was measured by means of the Karl Fischer coulometric titration using a CA-06 manufactured by Mitsubishi Chemical Analytech Co., Ltd.

6. Storage Characteristics

The initial efficiencies of the negative electrode material were measured respectively immediately after being manufactured and after the following storage test using the following method. Next, the change ratios of the initial efficiency were respectively computed.

(Storage Test)

The negative electrode material (1 g) was held in an apparatus of a small-sized environment tester (SH-241 manufactured by ESPEC Corp.) for seven days under conditions of a temperature of 40° C. and a relative humidity of 90% RH. Meanwhile, the negative electrode material was left to stand in the apparatus in a state of being spread to be as thin as possible in a container having a length of 5 cm, a width of 8 cm, and a height of 1.5 cm. After that, the negative electrode material was dried by being held under conditions of a temperature of 130° C. and a nitrogen atmosphere for one hour.

(1) Production of Half-Cell

Carboxymethyl cellulose (manufactured by Daicel FineChem Ltd., CMC Daicel 2200) (1.5 parts), styrene/butadiene rubber (manufactured by JSR corporation, TRD-2001) (3.0 parts), acetylene black (manufactured by Denka Company Limited, DENKA BLACK) (2.0 parts), and distilled water (100 parts) were added to the negative electrode material (100 parts) obtained in each of examples and comparative examples described below, and the components were stirred and mixed together using a planetary centrifugal mixer, thereby preparing a negative electrode slurry.

The prepared negative electrode slurry was applied to a single surface of a 14 μm-thick copper foil (manufactured by Furukawa Electric Co., Ltd., NC-WS), then, was preliminarily dried in the air at 60° C. for two hours, and subsequently, was dried in a vacuum at 120° C. for 15 hours. After vacuum-drying, an electrode was pressure-molded using a roll press. The electrode was cut out in a disc shape having a diameter of 13 mm, thereby producing a negative electrode. The thickness of a negative electrode active material layer was 50 μm.

A disc having a diameter of 12 mm and a thickness of 1 mm was formed using metallic lithium, thereby producing a counter electrode. In addition, a polyolefin porous film (manufactured by Celgard, LLC., trade name: CELGARD 2400) was used as a separator.

The above-described negative electrode, counter electrode, and separator were used, a substance obtained by adding LiPF₆ to a solvent mixture obtained by mixing ethylene carbonate and diethylene carbonate in a volume ratio of 1:1 in a ratio of 1 M was used as an electrolytic solution, thereby manufacturing a bipolar half-cell having a 2032 coin cell shape in a glove box with an argon atmosphere, and evaluations described below were carried out on the half-cell.

(2) Charging and Discharging of Half-Cell

The half-cell was charged and discharged under the following conditions.

Measurement temperature: 25° C.

Charging method: a constant current and constant voltage method, charge current: 25 mA/g, charge voltage: 0 mV, end-of-charge current: 2.5 mA/g

Discharging method: a constant current method, discharge current: 25 mA/g, end-of-discharge voltage: 2.5 V

In addition, on the basis of the charge capacity value and the discharge capacity value obtained under the above-described conditions, the charge capacity and discharge capacity per gram of the negative electrode material [mAh/g] were obtained. In addition, the initial efficiency and the change ratio of the initial efficiency were obtained using the following expressions.

Initial efficiency [%]=100×(discharge capacity)/(charge capacity)

Change ratio of initial efficiency [%]=100×(initial efficiency after storage test)/(initial efficiency immediately after manufacturing)

7. Volume of Fine Pores

The volume of fine pores by means of a mercury press-in method was measured using an AUTOPORE 1119420 manufactured by Micrometrics.

The negative electrode material was put into a specimen container and was degassed at a pressure of 2.67 Pa or lower for 30 minutes. Subsequently, mercury was introduced into the specimen container, and the mercury was pressed into fine pores in the negative electrode material by gradually increasing the pressure (the peak pressure: 414 MPa). The fine pore volume distribution in the negative electrode material was measured using the following expression from a relationship between the pressure at this time and the amount of the mercury pressed-in. The volume of the mercury pressed into the negative electrode material at a pressure in a range of a pressure corresponding to a fine pore diameter of 5 μm (0.25 MPa) to the peak pressure (414 MPa, corresponding to a fine pore diameter of 3 nm) was considered as the volume of fine pores having a fine pore diameter of 5 μm or lower. Regarding the computation of the fine pore diameter, in a case in which mercury is pressurized into cylindrical fine pores having a diameter of D at a pressure of P, when the surface tension of mercury is represented by γ, and the contact angle between mercury and a fine pore wall is represented by θ, the following expressions are established from the equilibrium between the surface tension and the pressure exerting on the cross section of a fine pore.

−πDγ cos θ=π(D/2)²·P

D=(−4γ cos θ)/P

Here, the surface tension of mercury was set to 484 dyne/cm, the contact angle between mercury and carbon was set to 130 degrees, the pressure P was expressed in MPa, the fine pore diameter D was expressed in μm, and a relationship between the pressure P and the fine pore diameter D was obtained from the following expression.

D=1.27/P

8. Measurement of Density

ρ^{B}: Measured by means of a butanol method according to the method specified by JIS R7212

ρ^{H}: Measured at 23° C. after a specimen was dried at 120° C. for two hours using a dry-type density meter AccuPyc 1330 manufactured by Micromeritics. The pressure was a gauge pressure at all times and a pressure obtained by subtracting the ambient pressure from the absolute pressure.

A measurement apparatus includes a specimen chamber and an expansion chamber, and the specimen chamber includes a pressure meter for measuring the pressure in the chamber. The specimen chamber and the expansion chamber are connected to each other through a coupling tube including a valve. A helium gas introduction tube including a throttle valve is connected to the specimen chamber, and a helium gas discharge tube including a throttle valve is connected to the expansion chamber.

The density was measured in the following fashion. The volume (V_{CELL}) of the specimen chamber and the volume (V_{EXP}) of the expansion chamber were measured in advance using a bogey tube.

A specimen was put into the specimen chamber, and the inside of the apparatus was substituted with helium gas by injecting helium gas through the helium gas introduction tube of the specimen chamber, the coupling tube, and the helium gas discharge tube of the expansion chamber for two hours. Next, the valve between the specimen chamber and the expansion chamber and the valve of the helium gas discharge tube from the expansion chamber were closed, and helium gas was introduced through the helium gas introduction tube of the specimen chamber until the pressure reached 134 kPa. After that, the throttle valve of the helium gas introduction tube was closed. The pressure (P₁) of the specimen chamber of 5 minutes after the closing of the throttle value was measured. Next, the valve between the specimen chamber and the expansion chamber was opened, helium gas was set to the expansion chamber, and the pressure (P₂) at this time was measured.

The volume (V_{SAMP}) of the specimen was computed using the following expression.

V_{SAMP}=V_{CELL}−V_{EXP}/[(P1/P2)−1]

Therefore, when the weight of the specimen was represented by W_{SAMP}, the density satisfied ρ^{H}=W_{SAMP}/V_{SAMP}

9. Observation of Cross Section of Negative Electrode Material Using Optical Microscope

The negative electrode material (approximately 10% by weight) was added to a liquid-phase epoxy resin, the components were well mixed together, and then the mixture was poured into a mold form, thereby embedding the negative electrode material in the epoxy resin. Next, the mixture was held at 120° C. for 24 hours, thereby curing the epoxy resin. After that, the epoxy resin was cut at an appropriate position so that the negative electrode material became exposed on the surface, and the cut surface was polished to a mirror-like surface. Next, bright field observation and image capturing of the cross section of the negative electrode material was carried out using an optical microscope (Axioskop2 MAT manufactured by Carl Zeiss) at a magnification of 1000 times.

10. Measurement of Total Water Absorption Amount

The negative electrode material (1 g) was dried in a vacuum at 200° C. for 24 hours, and then the weight of the negative electrode was measured. Next, the negative electrode was held in an apparatus of a small-sized environment tester (SH-241 manufactured by ESPEC Corp.) for 120 hours under conditions of a temperature of 40° C. and a relative humidity of 90% RH. Meanwhile, the negative electrode material was left to stand in the apparatus in a state of being spread to be as thin as possible in a container having a length of 5 cm, a width of 8 cm, and a height of 1.5 cm. After that, the weight of the negative electrode material was measured, and the total water absorption amount was measured using the following expression.

Total water absorption amount [%]=100×(weight after 120-hour holding−weight after vacuum drying)/(weight after vacuum drying)

11. Measurement of Micro-Hardness of Negative Electrode Material Using Micro-Hardness Meter

The negative electrode material (approximately 10% by weight) was added to a liquid-phase epoxy resin, the components were well mixed together, and then the mixture was poured into a mold form, thereby embedding the negative electrode material in the epoxy resin. Next, the mixture was held at 120° C. for 24 hours, thereby curing the epoxy resin. After that, the epoxy resin was cut at an appropriate position so that the negative electrode material became exposed on the surface, and the cut surface was polished to a mirror-like surface. Next, the hardness and modulus of elasticity of a cross section of the negative electrode material were measured by means of an indentation test using an ultramicro-hardness meter (ENT-1100 manufactured by Elionix Inc.). The test conditions were based on ISO 14577. The test load was set to 50 mN, the holding duration was set to one second, the test environment was set to a temperature of 22° C. and a relative humidity of 52%, and a Berkovich indenter (a triangular pyramid, a dihedral angle: 115°) was used as an indenter.

The hardness and the modulus of elasticity were computed using the following methods.

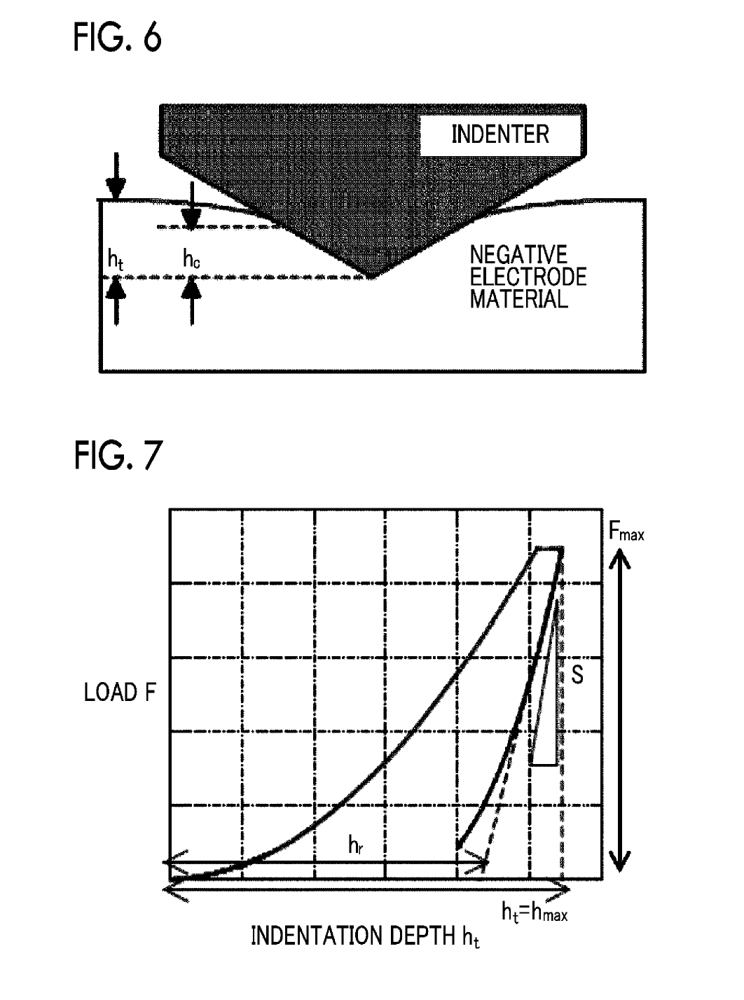

FIG. 6 is a schematic view of an indentation test. FIG. 7 is an example of the results of the indentation test. In FIG. 6, hₜ represents the indentation depth, and h_{c} represents the deformation depth. In FIG. 7, the vertical axis indicates a load F, and the horizontal axis indicates the indentation depth hₜ. The curve shows a curve obtained when the load is applied up to the maximum load of Fₘₐₓ so that the indentation depth hₜ reaches the maximum indentation depth hₘₐₓ and then the load is relieved. hᵣ represents an indentation depth at the intersection between a tangent line touching the curve at the maximum load when the load is relieved and the horizontal axis.

The hardness H is computed from the maximum load Fₘₐₓ in the indentation test and the projected area Aₚ of the deformation portion as shown in Expression (1) below.

H=Fₘₐₓ/Aₚ (1)

Here, the projected area Aₚ with respect to an ideal Berkovich indenter is as shown in Expression (2) below, and the deformation depth h_{c} is expressed using Expression (3) below.

Aₚ=23.96·h_{c}² (2)

h_{c}=hₘₐₓ−0.75×(hₘₐₓ−hᵣ) (3)

The modulus of elasticity E is computed from Expression (4) below.

1/Eᵣ=(1−νₛ²)/E+(1−νᵢ²)/Eᵢ

Here, νₛ and νᵢ represent the Poisson's ratios of the specimen and the indenter, Eᵢ represents the modulus of elasticity of the indenter, and Eᵣ represents the complex modulus of elasticity of a contact body represented by the following expression.

Eᵣ=(√π/2√Aₚ)·(1/S)

Here, S represents the slope (dh/dF) of the curve at the maximum load when the load is relieved. Meanwhile, in the diamond indenter at this time, the modulus of elasticity Eᵢ was set to 1141 GPa, the Poisson's ratio νᵢ was set to 0.07, and the Poisson's ratio νₛ of the specimen was set to 0.3.

12. Electron Beam Diffraction Measurement and Image Analysis Using Transmission Electron Microscope

The negative electrode material (approximately 10% by weight) was added to a liquid-phase epoxy resin, the components were well mixed together, and then the mixture was poured into a mold form, thereby embedding the negative electrode material in the epoxy resin. Next, the mixture was held at 120° C. for 24 hours, thereby curing the epoxy resin. After that, the epoxy resin was cut at an appropriate position so that the negative electrode material became exposed on the surface, and the cut surface was polished to a mirror-like surface. Next, a bright field of a cross section of the negative electrode material was observed at a magnification of 1000 times using an optical microscope (Axioskop2 MAT manufactured by Carl Zeiss), and one particle including a first region and a second region having different reflectivity values was selected.

Meanwhile, in a case in which a first region and a second region having different reflectivity values were not observed, one particle was arbitrarily selected.

The particle was thinned to a thickness of 100 nm using a focused ion beam machining observation apparatus (FIB) (FB-2200 manufactured by Hitachi High-Technologies Corporation), transmission electron microscopic observation of the first region and the second region was carried out using an electric field-emission transmission electron microscope (FE-TEM) (HF-2200 manufactured by Hitachi High-Technologies Corporation), and an electron beam diffraction image was obtained by means of diffraction method of a limited field of view. The measurement direction in the above-described observation was the same as the in-plane direction of the cross section of which the bright field was observed. In the above-described electric field-emission transmission electron microscopic observation, an image of the first region and the second region was captured using a CCD camera at an accelerated voltage of 200 kV in a limited field of view of 1 μm after an exposure time of four seconds.

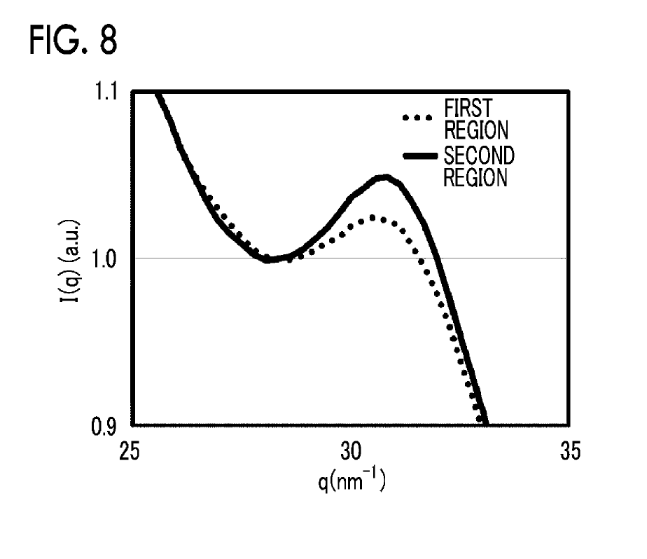

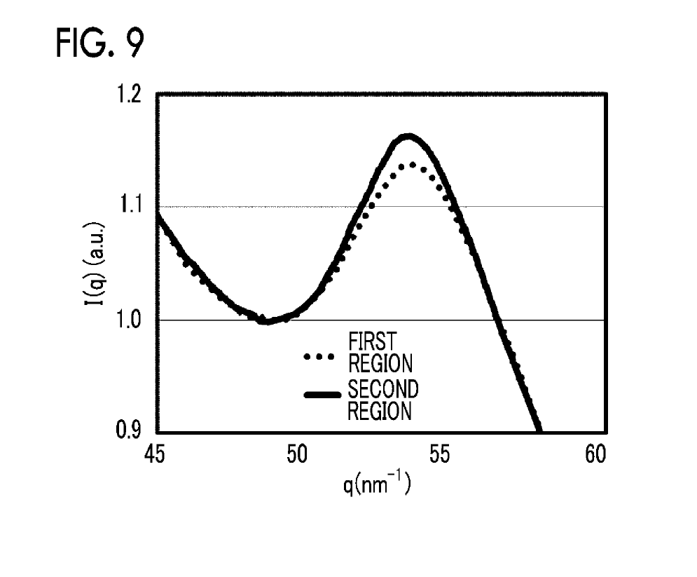

Next, the obtained electron beam diffraction image was circularly averaged using image analysis software (fit2d), thereby producing a one-dimensional image thereof. The scattering vector q was calibrated from the diffraction data of a Si single crystal, and the horizontal axis was expressed in q (nm⁻¹). The vertical axis indicates the intensity I(q) of the scattering vector. FIGS. 8 and 9 are examples of the curves obtained by means of image analyses. In the curves, the height was corrected with an assumption that the trough portion corresponded to 1. The lattice constants of graphite at which an electron beam scattered were 0.213 nm and 0.123 nm which respectively corresponded to the peaks in FIGS. 8 and 9.

[2] Manufacturing of Negative Electrode Material

### Example 1

Oxidized pitch was produced according to the method described in Paragraph “0051” of Japanese Unexamined Patent Publication No. 8-279358. Next, the following steps (a) to (f) were sequentially carried out using this oxidized pitch as a raw material, thereby obtaining a negative electrode material 1.

(a) The oxidized pitch (510 g) was left to stand in a state of being spread to be as thin as possible in a thermal treatment furnace having an in-furnace capacitance of 60 L (length: 50 cm, width: 40 cm, and height: 30 cm). After that, the temperature was increased from room temperature to 500° C. at 100° C./hour without any one of substitution with a reducing gas, substitution with an inert gas, circulation of a reducing gas, and circulation of an inert gas.

(b) Next, the oxidized pitch was degreased without any one of substitution with a reducing gas, substitution with an inert gas, circulation of a reducing gas, and circulation of an inert gas at 500° C. for two hours and then was cooled.

(c) The obtained powder was finely crushed using an oscillatory mill.

(d) After that, the obtained powder (204 g) was left to stand in a state of being spread to be as thin as possible in a thermal treatment furnace having an in-furnace capacitance of 24 L (length: 40 cm, width: 30 cm, and height: 20 cm). Next, the temperature was increased from room temperature to 1200° C. at 100° C./hour with substitution with and under circulation of an inert gas (nitrogen).

(e) Under circulation of an inert gas (nitrogen), the obtained powder was held at 1200° C. for eight hours, thereby carbonizing the powder.

(f) Under circulation of an inert gas (nitrogen), the powder was naturally cooled to 600° C. and was cooled from 600° C. to 100° C. or lower at 100° C./hour.

Meanwhile, the occupancy proportion of the raw material in a space for the carbonization treatment was 8.5 kg/m³.

### Example 2

A negative electrode material 2 was obtained by sequentially carrying out the following steps (a) to (f) using a phenol resin PR-55321B (manufactured by Sumitomo Bakelite Co., Ltd.), which was a thermosetting resin, as a raw material.

(a) The thermosetting resin (510 g) was left to stand in a state of being spread to be as thin as possible in a thermal treatment furnace having an in-furnace capacitance of 60 L (length: 50 cm, width: 40 cm, and height: 30 cm). After that, the temperature was increased from room temperature to 500° C. at 100° C./hour without any one of substitution with a reducing gas, substitution with an inert gas, circulation of a reducing gas, and circulation of an inert gas.

(b) Next, the thermosetting resin was degreased without anyone of substitution with a reducing gas, substitution with an inert gas, circulation of a reducing gas, and circulation of an inert gas at 500° C. for two hours and then was cooled.

(c) The obtained powder was finely crushed using an oscillatory mill.

(d) After that, the obtained powder (204 g) was left to stand in a state of being spread to be as thin as possible in a thermal treatment furnace having an in-furnace capacitance of 24 L (length: 40 cm, width: 30 cm, and height: 20 cm). Next, the temperature was increased from room temperature to 1200° C. at 100° C./hour with substitution with and under circulation of an inert gas (nitrogen).

(e) Under circulation of an inert gas (nitrogen), the obtained powder was held at 1200° C. for eight hours, thereby carbonizing the powder.

(f) Under circulation of an inert gas (nitrogen), the powder was naturally cooled to 600° C. and was cooled from 600° C. to 100° C. or lower at 100° C./hour.

Meanwhile, the occupancy proportion of the raw material in a space for the carbonization treatment was 8.5 kg/m³.

### Example 3

A negative electrode material 3 was produced using the same method as in Example 2 except for the fact that the occupancy proportion of the raw material in a space for the carbonization treatment was 3.5 kg/m³.

### Example 4

A negative electrode material 4 was produced using the same method as in Example 2 except for the fact that the occupancy proportion of the raw material in a space for the carbonization treatment was 0.9 kg/m³.

### Example 5

A negative electrode material 5 was produced using the same method as in Example 2 except for the fact that the occupancy proportion of the raw material in a space for the carbonization treatment was 0.5 kg/m³.

### Example 6

A negative electrode material 6 was produced using the same method as in Example 2 except for the fact that the occupancy proportion of the raw material in a space for the carbonization treatment was 0.3 kg/m³.

### Example 7

A negative electrode material 7 was produced using the same method as in Example 2 except for the fact that the occupancy proportion of the raw material in a space for the carbonization treatment was 9.0 kg/m³.

### Example 8

A negative electrode material 8 was produced using the same method as in Example 2 except for the fact that the occupancy proportion of the raw material in a space for the carbonization treatment was 0.16 kg/m³.

### Comparative Example 1

A negative electrode material 9 was produced using the same method as in Example 1 except for the fact that the occupancy proportion of the raw material in a space for the carbonization treatment was 16.0 kg/m³.

### Example 9

A negative electrode material 10 was produced using the same method as in Example 2 except for the fact that the occupancy proportion of the raw material in a space for the carbonization treatment was 16.0 kg/m³.

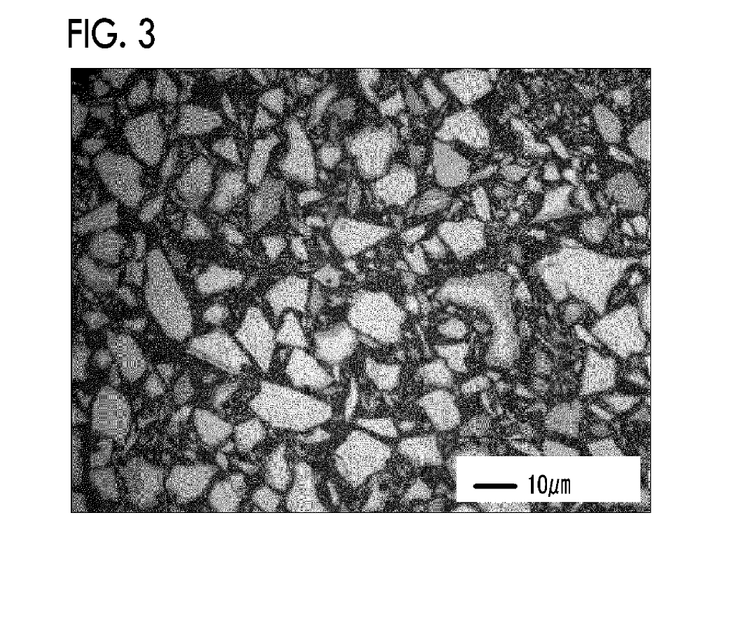

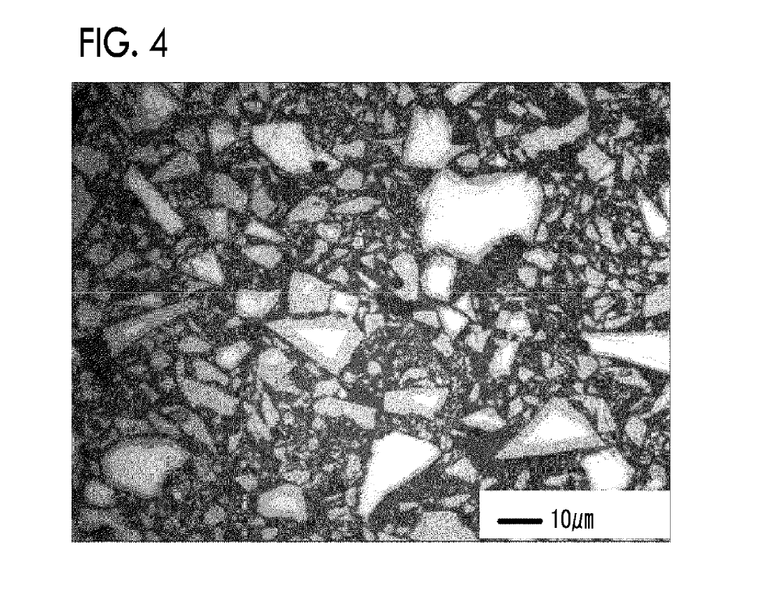

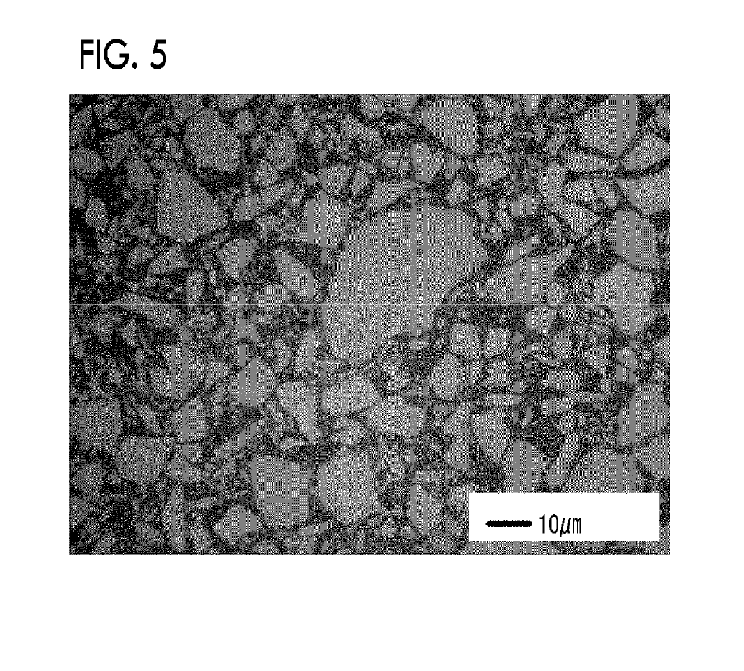

A variety of evaluations described above were carried out on the respective negative electrode materials obtained in the examples and the comparative examples. The results are shown in Table 1. In addition, FIGS. 3, 4, and 5 respectively show optical microscopic images of cross sections of the negative electrode materials obtained in Examples 1 and 5 and Comparative Example 1.

The negative electrode materials obtained in the respective examples included a first region and a second region having different hardness values measured by means of micro-hardness measurement.

In addition, the negative electrode materials obtained in the respective examples included a first region and a second region having different intensities of the peak, which corresponded to the lattice constant of graphite, of the curve obtained by analyzing an electron beam diffraction image observed using a transmission electron microscope.

A lithium ion battery produced using a negative electrode material having the above-described structure had excellent storage characteristics and an excellent charge and discharge capacity.

On the other hand, the negative electrode material obtained in Comparative Example 1 did not include a first region and a second region having different hardness values measured by means of micro-hardness measurement.

In addition, the negative electrode materials obtained in Comparative Example 1 did not include a first region and a second region having different intensities of the peak, which corresponded to the lattice constant of graphite, of the curve obtained by analyzing an electron beam diffraction image observed using a transmission electron microscope.

As described above, a lithium ion battery produced using the negative electrode material obtained in a comparative example had poorer storage characteristics and a poorer charge and discharge capacity than the negative electrode materials obtained in the respective examples.

TABLE 1

| Manufacturing | | | | | |
|---|---|---|---|---|---|
| method | Example 1 | Example 2 | Example 3 | Example 4 | Example 5 |
| Raw material | Petroleum | Thermosetting | Thermosetting | Thermosetting | Thermosetting |
| | pitch | resin | resin | resin | resin |
| Space occupancy | 8.5 | 8.5 | 3.5 | 0.9 | 0.5 |
| proportion | | | | | |
| [kg/m³] | | | | | |
| Properties of | | | | | |
| negative | | | | | |
| electrode | | | | | |
| material | | | | | |
| Amount of | 0.19 | 0.14 | 0.08 | 0.05 | 0.04 |
| moisture by | | | | | |
| means of Karl | | | | | |
| Fischer method | | | | | |
| (200° C.) [% by | | | | | |
| mass] | | | | | |
| Total water | 2.0 | 2.4 | 2.4 | 2.0 | 2.2 |
| absorption | | | | | |
| amount [% by | | | | | |
| mass] | | | | | |
| Specific | 5.3 | 5.2 | 5.5 | 5.7 | 5.9 |
| surface area | | | | | |
| [m²/g] | | | | | |
| CO₂ adsorption | 9.5 | 9.4 | 7.5 | 7.4 | 5.5 |
| amount [mL/g] | | | | | |
| Helium | 1.13 | 1.12 | 1.10 | 1.09 | 1.13 |
| density/butanol | | | | | |
| density | | | | | |
| Helium density | 1.93 | 1.91 | 1.91 | 1.89 | 1.93 |
| [g/cm³] | | | | | |
| Butanol density | 1.71 | 1.71 | 1.74 | 1.73 | 1.71 |
| [g/cm³] | | | | | |
| Volume of fine | 0.52 | 0.49 | 0.48 | 0.48 | 0.47 |
| pores having | | | | | |
| fine pore | | | | | |
| diameter of | | | | | |
| 0.003 μm to 5 μm | | | | | |
| [mL/g] | | | | | |
| Average | 9.0 | 8.8 | 8.7 | 8.5 | 8.9 |
| particle | | | | | |
| diameter D₅₀ | | | | | |
| [μm] | | | | | |
| Average layer | 0.375 | 0.368 | 0.370 | 0.373 | 0.370 |
| plane spacing | | | | | |
| [nm] | | | | | |
| Size of | 4.5 | 3.5 | 2.5 | 2.4 | 1.5 |
| crystallite | | | | | |
| [nm] | | | | | |
| Observation of | | | | | |
| cross section | | | | | |
| of negative | | | | | |
| electrode | | | | | |
| material using | | | | | |
| micro-hardness | | | | | |
| meter | | | | | |
| Presence or | Present | Present | Present | Present | Present |
| absence of | | | | | |
| first region | | | | | |
| and second | | | | | |
| region having | | | | | |
| different | | | | | |
| hardness values | | | | | |
| Hardness of | 2.1 | 3.1 | 3.1 | 3.3 | 2.1 |
| first region | | | | | |
| [GPa] | | | | | |
| Hardness of | 4.1 | 5.9 | 5.3 | 5.4 | 4.5 |
| second region | | | | | |
| [GPa] | | | | | |
| Modulus of | 22.4 | 26.7 | 27.8 | 27.7 | 22.0 |
| elasticity of | | | | | |
| second region | | | | | |
| [GPa] | | | | | |
| Measurement of | | | | | |
| peak intensity | | | | | |
| of electron | | | | | |
| beam | | | | | |
| diffraction | | | | | |
| image using | | | | | |
| transmission | | | | | |
| electron | | | | | |
| microscope | | | | | |
| Presence or | Present | Present | Present | Present | Present |
| absence of | | | | | |
| first region | | | | | |
| and second | | | | | |
| region having | | | | | |
| different peak | | | | | |
| intensities | | | | | |
| corresponding | | | | | |
| to 0.213 nm | | | | | |
| Presence or | Present | Present | Present | Present | Present |
| absence of | | | | | |
| first region | | | | | |
| and second | | | | | |
| region having | | | | | |
| different peak | | | | | |
| intensities | | | | | |
| corresponding | | | | | |
| to 0.123 nm | | | | | |
| Comparison of | Higher in | Higher in | Higher in | Higher in | Higher in second |
| peaks | second region | second region | second region | second region | region |
| corresponding | | | | | |
| to 0.213 nm | | | | | |
| Comparison of | Higher in | Higher in | Higher in | Higher in | Higher in second |
| peaks | second region | second region | second region | second region | region |
| corresponding | | | | | |
| to 0.123 nm | | | | | |
| Observation of | | | | | |
| cross section of | | | | | |
| negative electrode | | | | | |
| material using | | | | | |
| optical microscope | | | | | |
| Presence or absence | Present | Present | Present | Present | Present |
| of first region and | | | | | |
| second region | | | | | |
| having different | | | | | |
| reflectivity | | | | | |
| values | | | | | |
| Reflectivity at | Discontinuously | Discontinuously | Discontinuously | Discontinuously | Discontinuously |
| interface between | change | change | change | change | change |
| first region and | | | | | |
| second region | | | | | |
| Whether or not | Greater | Greater | Greater | Greater | Greater |
| reflectivity (B) in | | | | | |
| second region is | | | | | |
| greater than | | | | | |
| reflectivity (A) in | | | | | |
| first region | | | | | |
| Battery | | | | | |
| characteristics | | | | | |
| Immediately after | | | | | |
| manufacturing | | | | | |
| Charge capacity | 411 | 414 | 461 | 486 | 507 |
| [mAh/g] | | | | | |
| Discharge capacity | 362 | 364 | 406 | 428 | 4 |
| [mAh/g] | | | | | |
| Initial efficiency | 88 | 88 | 88 | 88 | 88 |
| [%] | | | | | |
| After storage test | | | | | |
| Charge capacity | 436 | 426 | 472 | 491 | 506 |
| [mAh/g] | | | | | |
| Discharge capacity | 362 | 362 | 406 | 427 | 445 |
| [mAh/g] | | | | | |
| Initial efficiency | 83 | 85 | 86 | 87 | 88 |
| [%] | | | | | |
| Change ratio of | 94 | 97 | 98 | 99 | 100 |
| initial efficiency | | | | | |
| [%] | | | | | |

| Manufacturing | | | | | Comparative |
|---|---|---|---|---|---|
| method | Example 6 | Example 7 | Example 8 | Example 9 | Example 1 |
| Raw material | Thermosetting | Thermosetting | Thermosetting | Thermosetting | Petroleum |
| | resin | resin | resin | resin | pitch |
| Space occupancy | 0.3 | 9.0 | 0.16 | 16.0 | 16.0 |
| proportion | | | | | |
| [kg/m³] | | | | | |
| Properties of | | | | | |
| negative | | | | | |
| electrode | | | | | |
| material | | | | | |
| Amount of | 0.04 | 0.10 | 0.09 | 0.23 | 0.25 |
| moisture by | | | | | |
| means of Karl | | | | | |
| Fischer method | | | | | |
| (200° C.) [% by | | | | | |
| mass] | | | | | |
| Total water | 2.2 | 2.2 | 2.2 | 2.5 | 2.4 |
| absorption | | | | | |
| amount [% by | | | | | |
| mass] | | | | | |
| Specific | 5.8 | 5.8 | 5.2 | 17 | 0.9 |
| surface area | | | | | |
| [m²/g] | | | | | |
| CO₂ adsorption | 5.6 | 8.0 | 5.4 | 12.0 | 11.0 |
| amount [mL/g] | | | | | |
| Helium | 1.07 | 1.23 | 1.13 | 1.29 | 1.30 |
| density/butanol | | | | | |
| density | | | | | |
| Helium density | 1.85 | 2.07 | 1.93 | 2.09 | 2.10 |
| [g/cm³] | | | | | |
| Butanol density | 1.73 | 1.68 | 1.71 | 1.62 | 1.62 |
| [g/cm³] | | | | | |
| Volume of fine | 0.48 | 0.50 | 0.45 | 0.60 | 0.58 |
| pores having | | | | | |
| fine pore | | | | | |
| diameter of | | | | | |
| 0.003 μm to 5 μm | | | | | |
| [mL/g] | | | | | |
| Average | 8.9 | 9.0 | 8.8 | 9.5 | 10.0 |
| particle | | | | | |
| diameter D₅₀ | | | | | |
| [μm] | | | | | |
| Average layer | 0.371 | 0.374 | 0.370 | 0.371 | 0.372 |
| plane spacing | | | | | |
| [nm] | | | | | |
| Size of | 1.6 | 3.5 | 1.2 | 5.5 | 6.0 |
| crystallite | | | | | |
| [nm] | | | | | |
| Observation of | | | | | |
| cross section | | | | | |
| of negative | | | | | |
| electrode | | | | | |
| material using | | | | | |
| micro-hardness | | | | | |
| meter | | | | | |
| Presence or | Present | Present | Present | Present | Absent |
| absence of | | | | | |
| first region | | | | | |
| and second | | | | | |
| region having | | | | | |
| different | | | | | |
| hardness values | | | | | |
| Hardness of | 2.1 | 0.5 | 4.5 | 10.0 | — |
| first region | | | | | |
| [GPa] | | | | | |
| Hardness of | 5.0 | 1.1 | 6.8 | 7.5 | — |
| second region | | | | | |
| [GPa] | | | | | |
| Modulus of | 24.0 | 9.2 | 28.0 | 31.0 | — |
| elasticity of | | | | | |
| second region | | | | | |
| [GPa] | | | | | |
| Measurement of | | | | | |
| peak intensity | | | | | |
| of electron | | | | | |
| beam | | | | | |
| diffraction | | | | | |
| image using | | | | | |
| transmission | | | | | |
| electron | | | | | |
| microscope | | | | | |
| Presence or | Present | Present | Present | Present | Absent |
| absence of | | | | | |
| first region | | | | | |
| and second | | | | | |
| region having | | | | | |
| different peak | | | | | |
| intensities | | | | | |
| corresponding | | | | | |
| to 0.213 nm | | | | | |
| Presence or | Present | Present | Present | Present | Absent |
| absence of | | | | | |
| first region | | | | | |
| and second | | | | | |
| region having | | | | | |
| different peak | | | | | |
| intensities | | | | | |
| corresponding | | | | | |
| to 0.123 nm | | | | | |
| Comparison of | Higher in | Higher in | Higher in | Higher in | — |
| peaks | second region | second region | second region | first region | |
| corresponding | | | | | |
| to 0.213 nm | | | | | |
| Comparison of | Higher in | Higher in | Higher in | Higher in | — |
| peaks | second region | second region | second region | first region | |
| corresponding | | | | | |
| to 0.123 nm | | | | | |
| Observation of | | | | | |
| cross section of | | | | | |
| negative electrode | | | | | |
| material using | | | | | |
| optical microscope | | | | | |
| Presence or absence | Present | Present | Present | Absent | Absent |
| of first region and | | | | | |
| second region | | | | | |
| having different | | | | | |
| reflectivity | | | | | |
| values | | | | | |
| Reflectivity at | Discontinuously | Discontinuously | Discontinuously | — | — |
| interface between | change | change | change | | |
| first region and | | | | | |
| second region | | | | | |
| Whether or not | Greater | Greater | Greater | — | — |
| reflectivity (B) in | | | | | |
| second region is | | | | | |
| greater than | | | | | |
| reflectivity (A) in | | | | | |
| first region | | | | | |
| Battery | | | | | |
| characteristics | | | | | |
| Immediately after | | | | | |
| manufacturing | | | | | |
| Charge capacity | 500 | 490 | 505 | 408 | 410 |
| [mAh/g] | | | | | |
| Discharge capacity | 445 | 431 | 444 | 359 | 361 |
| [mAh/g] | | | | | |
| Initial efficiency | 89 | 88 | 88 | 88 | 88 |
| [%] | | | | | |
| After storage test | | | | | |
| Charge capacity | 501 | 485 | 504 | 449 | 462 |
| [mAh/g] | | | | | |
| Discharge capacity | 446 | 422 | 442 | 359 | 360 |
| [mAh/g] | | | | | |
| Initial efficiency | 89 | 87 | 88 | 80 | 78 |
| [%] | | | | | |
| Change ratio of | 100 | 99 | 100 | 91 | 89 |
| initial efficiency | | | | | |
| [%] | | | | | |

The present application claims priority on the basis of Japanese Patent Application No. 2013-173126 filed on Aug. 23, 2013 and Japanese Patent Application No. 2013-173174 filed on Aug. 23, 2013, and the contents thereof are all incorporated thereinto.

1. A negative electrode material which is a carbonaceous negative electrode material used for an alkali metal ion battery,
wherein an average layer plane spacing d₀₀₂ of a (002) plane obtained using an X-ray diffraction method in which a CuKα ray is used as a radiation source is 0.340 nm or greater, and
when a cross section of the negative electrode material is exposed by cutting and polishing a cured substance obtained by embedding the negative electrode material in an epoxy resin and curing the epoxy resin, the cross section includes a first region and a second region having different hardness values measured by means of micro-hardness measurement.

2. The negative electrode material according to claim 1,
wherein the first region is present along an exterior of the cross section of the negative electrode material, and
the second region is present inside the first region.

3. The negative electrode material according to claim 1,
wherein hardness of the second region measured by means of micro-hardness measurement is greater than hardness of the first region measured by means of micro-hardness measurement.

4. The negative electrode material according to claim 1,
wherein the hardness of the second region measured by means of micro-hardness measurement is equal to or higher than 1 GPa and equal to or lower than 7 GPa.

5. The negative electrode material according to claim 1,
wherein a modulus of elasticity of the second region measured by means of micro-hardness measurement is equal to or higher than 9 GPa and equal to or lower than 30 GPa.

6. A negative electrode material which is a carbonaceous negative electrode material used for an alkali metal ion battery,
wherein an average layer plane spacing d₀₀₂ of a (002) plane obtained using an X-ray diffraction method in which a CuKα ray is used as a radiation source is 0.340 nm or greater, and
when a cross section of the negative electrode material is exposed by cutting and polishing a cured substance obtained by embedding the negative electrode material in an epoxy resin and curing the epoxy resin, the cross section includes a first region and a second region having different intensities of a peak, which corresponds to a lattice constant of graphite, of a curve obtained by means of an image analysis of an electron beam diffraction image observed using a transmission electron microscope.

7. The negative electrode material according to claim 6,
wherein the first region is present along an exterior of the cross section of the negative electrode material, and
the second region is present inside the first region.

8. The negative electrode material according to claim 6,
wherein the peak intensity in the second region is greater than the peak intensity in the first region.

9. The negative electrode material according to claim 1,
wherein, when a bright field is observed at a magnification of 1000 times using an optical microscope, reflectivity in the first region is different from reflectivity in the second region.

10. The negative electrode material according to claim 9,
wherein the reflectivity discontinuously changes in an interface between the first region and the second region.

11. The negative electrode material according to claim 9,
wherein reflectivity (B) in the second region is greater than reflectivity (A) in the first region.

12. The negative electrode material according to claim 1,
wherein, when moisture generated after the negative electrode material is preliminarily dried by holding the negative electrode material under conditions of a temperature of 40° C. and a relative humidity of 90% RH for 120 hours and then holding the negative electrode material under conditions of a temperature of 130° C. and a nitrogen atmosphere for one hour, and then the preliminarily dried negative electrode material is held at 200° C. for 30 minutes is measured by means of the Karl Fischer coulometric titration,
an amount of moisture generated from the preliminarily dried negative electrode material is equal to or larger than 0.01% by mass and equal to or smaller than 0.20% by mass with respect to 100% by mass of the preliminarily dried negative electrode material.

13. The negative electrode material according to claim 1,
wherein, when a half-cell produced using a negative electrode formed of the negative electrode material as a negative electrode, metallic lithium as a counter electrode, and a substance obtained by dissolving LiPF₆ in a carbonate-based solvent in a ratio of 1 M as an electrolytic solution is charged by means of a constant current and constant voltage method under conditions of a temperature of 25° C., a charge current of 25 mA/g, a charge voltage of 0 mV, and an end-of-charge current of 2.5 mA/g and then is discharged by means of a constant current method under conditions of a discharge current of 25 mA/g and an end-of-discharge voltage of 2.5 V, a discharge capacity is 360 mAh/g or higher.

14. The negative electrode material according to claim 1,
wherein a particle diameter D₅₀ at which accumulation reaches 50% in a volume-based cumulative distribution is equal to or larger than 1 μm and equal to or smaller than 50 μm.

15. The negative electrode material according to claim 1,
wherein a specific surface area by means of a BET 3-point method in nitrogen adsorption is equal to or larger than 1 m²/g and equal to or smaller than 15 m²/g.

16. The negative electrode material according to claim 1,
wherein an adsorption amount of carbonate gas is equal to or larger than 0.05 ml/g and lower than 10 ml/g.

17. The negative electrode material according to claim 1,
wherein a volume of fine pores having a fine pore diameter, which is obtained using a mercury press-in method, that is equal to or larger than 0.003 μm and equal to or smaller than 5 μm is lower than 0.55 ml/g.

18. The negative electrode material according to claim 1,
wherein a density (ρ^{B}) measured using butanol as a substitution medium is equal to or higher than 1.50 g/cm³ and equal to or lower than 1.80 g/cm³.

19. The negative electrode material according to claim 1,
wherein a density (ρ^{H}) measured using helium gas as a substitution medium is equal to or higher than 1.80 g/cm³ and equal to or lower than 2.10 g/cm³.

20. A negative electrode active material comprising:
the negative electrode material according to claim 1.

21. The negative electrode active material according to claim 20, further comprising:
a negative electrode material which is different type from the negative electrode material.

22. The negative electrode active material according to claim 21,
wherein the different type of the negative electrode material is a graphite material.

23. A negative electrode comprising:
the negative electrode active material according to claim 20.

24. An alkali metal ion battery comprising at least:
the negative electrode according to claim 23, an electrolyte, and a positive electrode.

25. The alkali metal ion battery according to claim 24 which is a lithium ion battery or a sodium ion battery.
